(19) United States
(12) Patent Application Publication
(10) Pub. No.: US 2009/0008115 A1
(43) Pub. Date: Jan. 8, 2009

(54) Hand-held power tool with a slip clutch

(76) Inventors: Kevin Guo, Shanghai (CN); Jens Neumann, Grabs (SE); Markus Harlmann, Mauerstetten (DE)

Correspondence Address: ABELMAN, FRAYNE & SCHWAB, 666 THIRD AVENUE, 10TH FLOOR, NEW YORK, NY, 10017, US

(21) Appl. No.: 12/217,305

(22) Filed: Jul. 2, 2008

(30) Foreign Application Priority Data
Jul. 4, 2007 (DE) 10 2007 000 365.1

(51) Int. Cl. B25B 21/00

(52) U.S. Cl. 173/176

(57) ABSTRACT

A hand-held power tool includes a drive element (12), a driven spindle (16), and a slip clutch (14) arranged between the drive element (12) and the driven spindle (16) and including a plurality of coupling bodies (24) engageable with a set of drive side receptacles (26) and a set of driven side receptacles (28), the plurality of coupling bodies (24) disengaging from the drive side receptacles (26) or the driven side receptacles (28) against a spring-biasing force (F), and the driven side receptacles (28) being formed by recesses provided in the driven spindle (16) and opening, with respect to the rotational axis (A), in a radial direction.

### BACKGROUND OF THE INVENTION

1. Field of the Invention

The present invention relates to a hand-held power tool including a driven spindle extendable along its rotational axis and drive means for driving the driven spindle. A slip clutch is arranged between the drive means and the driven spindle for transmitting torque from the drive means to the driven spindle and has a plurality of coupling bodies. The coupling bodies engage a set of drive side receptacles and a set of driven side receptacles. The coupling bodies disengage from the set of drive side receptacles or the set of driven side receptacles against a spring biasing force.

2. Description of the Prior Art

In hand-held power tools of the type discussed above, a fixed or adjustable maximum value for the transmitted torque can be preset. Upon achieving the maximum value, the coupling bodies disengage from one of the above-mentioned sets of receptacles whereby the connection between the jointly rotatable drive means and driven spindle is interrupted, and the driven spindle is not driven any more. In this way, damage of a produceable threaded connection or of the power tool is prevented.

German Publication DE 33 42 880 A1 discloses a clutch for an electrical tool and which provides for torque adjustment. To this end, there is provided an adjustable spring device for applying pressure to a spring plate in which a plurality of recesses is formed in which ball-shaped coupling bodies engage. The coupling bodies are arranged in correspondingly dimensioned bores of a positioning disc and simultaneously engage, with their sides remote from spring plate, in drive side receptacles formed in a rotatably supported drive gear wheel.

The drawback of the above-described clutch consists in a relatively large number of separate parts, which on one hand, increases manufacturing costs and, on the other hand, increases the danger of malfunction.

Accordingly, an object of the present invention is to eliminate the drawbacks of the known clutch and to provide a stable clutch that can be economically produced.

### SUMMARY OF THE INVENTION

This and other objects of the present invention, which will become apparent hereinafter, are achieved by providing a slip clutch in which the driven side receptacles are formed by recesses provided in the driven spindle and open, with respect to the rotational axis, in a radial direction.

The provision of the driven side receptacles directly in the driven spindle permits to eliminate additional, to the driven spindle, components for forming the driven side receptacles and connection means for connecting the additional components with the driven spindle and which insures joint rotation of the additional components with the driven spindle.

According to a particular advantageous embodiment of the present invention, the drive means is formed by a drive gear wheel that surrounds the driven spindle and in which the drive side receptacles are formed. With the drive gear wheel, the driving torque is transmitted from the drive gear wheel directly to the coupling bodies and from the coupling bodies directly to the driven spindle. As a result, the number of components, which is necessary for transmitting the torque, is reduced to a minimum, whereby simultaneously, a backlash, which occurs in the rotational direction between the drive gear wheel and the output shaft, and a resulting wear, can be reduced.

Advantageously, the drive means is supported on the driven spindle for displacement in the axial direction of the driven spindle, and the drive side receptacles are formed in a first end surface of the drive gear wheel. The spring applies the biasing force to a second end surface of the drive gear wheel remote from the first end surface. In this way, the drive gear wheel itself functions as a movable clutch component that, upon reaching a predetermined maximum value, disengages from the coupling bodies, moving away from the coupling bodies against the spring biasing force. In addition, the coupling bodies function as an end stop against which the drive gear wheel is preloaded by the spring. Thereby, additional movable clutch components and/or an additional end stop can be eliminated. This noticeably simplifies the clutch structure and reduces manufacturing costs.

Advantageously, the drive means has an overlapping surface for limiting the drive side receptacles in a radial direction, and which extends in an axial direction toward the first end surface over the drive side receptacles. Thereby, the coupling bodies can be held in engagement with the driven spindle only by the drive gear wheel. The overlapping surface insures that the coupling bodies continue to engage in the driven side receptacles when the drive gear wheel becomes disengaged from the coupling bodies.

Advantageously, the coupling bodies are formed as balls, and the receptacles are formed by rounded recesses. Thereby, conventional balls can be used as coupling bodies, and the recesses can be formed in the drive gear wheel and the driven spindle in a particular simple manner, which again reduces manufacturing costs.

Advantageously, the drive means forms a direct support for the spring. Thereby, a danger of malfunction, e.g., as a result of tilting, is prevented.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a partially cross-sectional view of a working tool-side portion of a hand-held power tool according to the present invention; and

FIG. 2 a perspective exploded view of a slip clutch of the hand-held power tool shown in FIG. 1.

### DETAILED DESCRIPTION OF THE PREFERRED EMBODIMENT

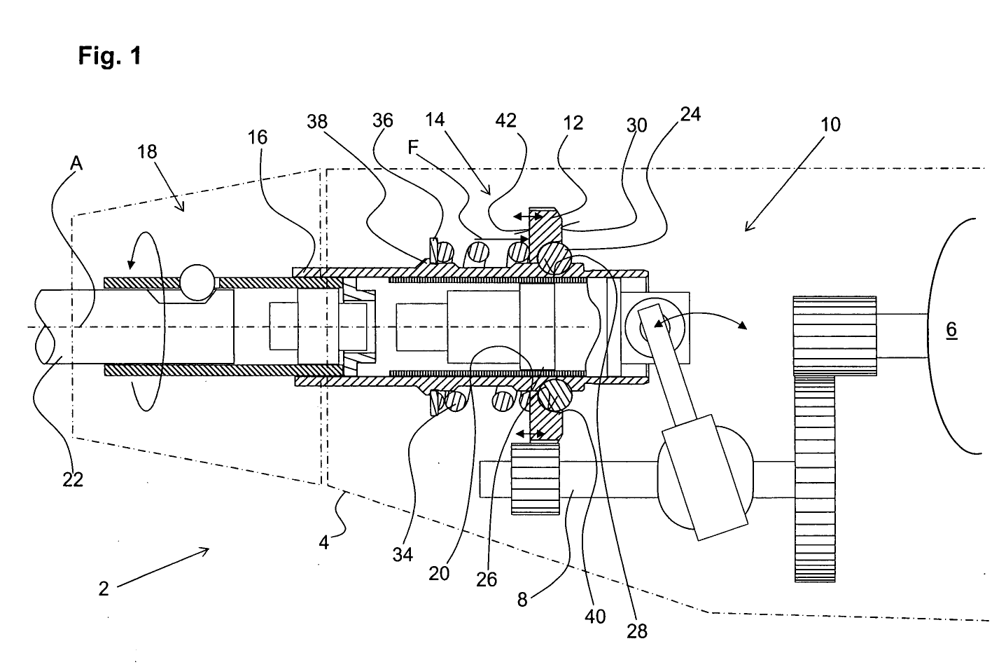

A hand-held power 2 according to the present invention, which is formed as a hammer drill and is shown in FIG. 1, includes a housing 4 and drive motor 6 which is located in the housing 4 and drives, with its forward-projecting shaft 8, a percussion mechanism 10 and drive means 12 in form of a driving gear rotatable about a rotational axis A.

A slip clutch, which is generally designated with a reference numeral 14, connects the drive means 12 with a generally cylindrical driven spindle 16 that extends centrally through a center bore 20 of the drive means 12. The drive means 12 is supported on the driven spindle 16 for an axial displacement therealong. A chuck 18, in which a working tool 22 such as, e.g., a hammer drill is received, is connected with the driven spindle 16 for joint rotation therewith.

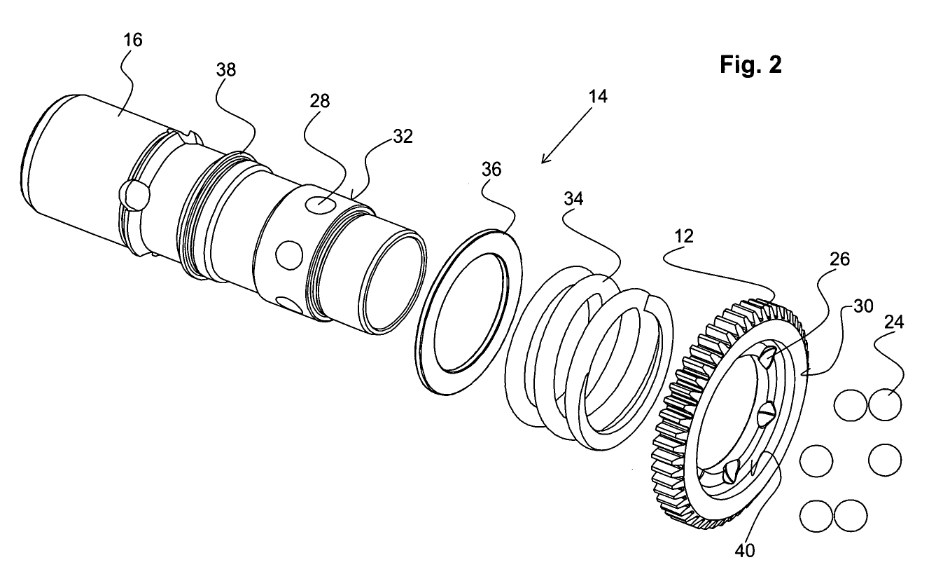

As shown in FIG. 2, the slip clutch 14 has a plurality of ball-shaped coupling bodies 24, and a corresponding number of drive side recesses 26 and driven side recesses 28 is provided, respectively, on the drive means 12 and the driven spindle 16. The drive side recesses 26 are formed by rounded, i.e., by, at least regionwise, cylindrical or spherical recesses provided in the central bore 20 of the drive means 12. The recesses 26 are open, with respect to the rotational axis A, in the radial direction toward the driven spindle 16 and in an axial direction toward a first end surface 30 of the drive means 12. The driven side recesses are formed as spherical recesses provided in the cylindrical surface 32 of the driven spindle 16 and open, with respect to the rotational axis A, in the radial direction.

The slip clutch 14 further has a spring member 34 formed, e.g., as a helical spring, and a support ring 36 mountable on a circumferential ledge 38 formed on the driven spindle 16.

As shown in FIG. 1, the coupling bodies 24 project into the driven side recesses 28, abutting, with their sides remote from the driven spindle 14, an overlapping surface 40 of the drive means 12 extending toward the end surface 30. The spring member 34, which is supported at its end remote from the drive means 12 against the support ring 36 mounted on the ledge 38 of the drive spindle 16, applies a biasing force F directly to the second end side 42 of the drive means 12 remote from the first end side 30.

A torque, which is generated during operation of the drive motor 6, is transmitted to the driven spindle 12 via the forward-projecting output shaft 8 of the motor 6 to the drive means 12. From the drive means 12, the torque is transmitted to the driven spindle 16 via coupling bodies 24 which engage in the drive side recesses 26 of the drive means 12 and in the driven side recesses 28 in the driven spindle 16. From the driven spindle 16, the torque is transmitted to the chuck 18 and to the working tool 22 received in the chuck 18.

In case the torque, which is transmitted to the working tool 22, increases as a result of an increased resistance to the working tool 22, and reaches a predetermined maximum value, the drive means 12 moves away from the coupling bodies 24 against the biasing force F until the drive side recesses 26 become disengaged from the coupling bodies 24, and the drive means 12 can rotate relative to the drive spindle 16.

The overlapping surface 40 extends in the axial direction far enough to reliably retain the coupling bodies 24 in the drive side recesses 28 of the drive spindle 12 even in the displaced condition of the drive means 12 even in the displaced condition of the drive means 12.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held power tool, comprising drive means (12); a driven spindle (16) extendable along a rotational axis (A) of the driven spindle (16); and a slip clutch (14) arranged between the drive means (12) and the driven spindle (16) for transmitting torque from the drive means (12) to the driven spindle (16), the slip clutch (14) including a plurality of coupling bodies (24) engageable with a set of drive side receptacles (26) and a set of driven side receptacles (28), and spring means (34) for biasing the coupling bodies (24) into engagement with the drive side receptacles (26) and driven side receptacles (28), the plurality of coupling bodies (24) disengaging from one of the set of drive side receptacles (26) and the set of driven side receptacles (28) against the biasing force (F) of the spring means (34), and the driven side receptacles (26) being formed by recesses provided in the driven spindle (16) and opening, with respect to the rotational axis (A), in a radial direction.

2. A hand-held power tool according to claim 1, wherein the drive means (12) is formed by a drive gear wheel that surrounds the driven spindle (16) and in which the drive side receptacles (26) are provided.

3. A hand-held power tool according to claim 2, wherein the drive means (12) is displaceably supported on the driven spindle (16), and wherein the drive side receptacles (26) are formed in a first end surface (30) of the drive gear wheel, and the spring means (34) apply the biasing force (F) to a second end surface (42) of the drive gear wheel remote from the first end surface (30).

4. A hand-held power tool according to claim 3, wherein the drive means (12) has an overlapping surface (40) for limiting the drive side receptacle (26) in a radial direction, the overlapping surface (40) extending in an axial direction toward the first end surface (30) over the drive side receptacles (26).

5. A hand-held power tool according to claim 1, wherein the coupling bodies (24) are formed as balls, and the drive side receptacles (26) and the driven side receptacles (28) are formed by rounded recesses.

6. A hand-held power tool according to claim 1, wherein the drive means (12) forms a direct support for the spring means (34).
